(19) United States
(12) Patent Application Publication
(10) Pub. No.: US 2003/0028132 A1
(43) Pub. Date: Feb. 6, 2003

(54) Massage pad with selectively placeable massage actuators

(75) Inventors: Paul A. Bastia, Cranston, RI (US); Alan E. Strick, Harrisville, RI (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/167,330

(22) Filed: Jun. 11, 2002

Related U.S. Application Data
(60) Provisional application No. 60/302,727, filed on Jul. 3, 2001.

(51) Int. Cl. A61H 23/02

(52) U.S. Cl. 601/57

(57) ABSTRACT

There is provided a massage pad having a surface for removeably retaining one or more selectively positionable massage actuators. The massage pad permits a user to selectably adjust the position of the one or more actuators in order to provide a variety of different massaging effects. Further, the massaging pad is provided with a controller for selectively controlling the actuation of the one or more massage actuators and a heating element to provide an even greater variety of massaging effects. Also, the massaging pad is adapted to cooperate with a variety of different therapeutic devices.

### BACKGROUND OF THE INVENTION

1. Field Of The Invention

The present invention relates to a massage device. More particularly, the present invention relates to a massage pad having various actuators selectively positionable on a pad or cushion.

2. Description of the Prior Art

Massage pads having a number of individual actuators are well known in the art. Such cushions may include a series of raised portions or nodes under which lies an actuator such as a vibrating motor. These motors are fixedly positioned on a pad such that when the pad is brought into engagement with a user of the device, the vibrating nodes massage a particular area of the body.

Vibrating massage pads of the prior art are typically in the form of a seat cushion having a lower seating portion and a back rest portion. To accommodate variations in user physiology, as well as one's positioning on the pad, a variety of actuators are employed to insure that the desired location to be massaged is covered by an actuator. To achieve a wide range of coverage, a variety of nodes, each having a motor, are employed. Such a design typically includes an array of nodes extending along the cushion. Each of the motors may be selectively energized by a controller, thereby permitting the user to turn on the particular message actuators as desired. In addition, different zones on the cushion may incorporate one or more actuators that may be selectively and individually energized. In addition, the controller may allow a user to vary the intensity and sequence of vibration of the various actuators.

The actuators are typically fixed within the cushion and are not movable by the user. Therefore, the cushion must include a significant number of actuators in order to ensure that a particular desired massage point on the body is in close proximity to an actuator. Since a numerous number of motors are required, such a device can be expensive to manufacture and difficult to control.

Accordingly, it would be desirable to provide an economical massage cushion that can accommodate a wide range of user physiologies, as well as have a broad coverage area, without employing a large number of actuators.

### SUMMARY OF THE INVENTION

It is an advantage of the present invention to provide a massage cushion having selectively positionable massage actuators.

It is another advantage of the present invention to provide a massage cushion having a surface for removably retaining a plurality of massage actuators.

It is a further advantage of the present invention to provide a massage cushion having a plurality of pockets each able to receive a massaging actuator.

It is another advantage of the present invention to provide a massage cushion having an attachment surface including a first attachment device and a massage actuator having a second attachment device securable to the first attachment device, wherein the massage actuator is removably securable to the attachment surface.

It is still another advantage of the present invention to provide a massage cushion including a plurality of vibrating motors, which are selectively positionable in discreet pockets formed in the massage cushion.

It is yet another advantage of the present invention to provide a massage cushion having a plurality of selectively positionable massage actuators, wherein the massage actuators are removably attachable to the cushion.

These and other advantages are obtainable by way of the preferred embodiments of the present invention including a cushioned surface having an attachment surface and a massage actuator removable securable to the attachment surface at a first position. The massage actuator is removable from the attachment surface and positionable to a second location on the attachment surface where it is removably securable thereto. There is also provided a control that is electrically connectable to the massage actuator for supplying power to the massage actuator.

### BRIEF DESCRIPTION OF THE DRAWINGS

FIG. 1 is a top front perspective view of the massage cushion of the present invention showing the pockets for receiving an actuator and wiring in dotted lines.

FIG. 2 is a rear perspective view of the massage cushion of FIG. 1 of the present invention.

FIG. 3 is an exploded perspective view illustrating a massaging actuator being inserted in the massage cushion of the present invention.

FIG. 4 is a top plan view of the controller of the present invention.

FIG. 5 is a back perspective view of an alternative embodiment of the massage cushion of the present invention.

FIG. 6 is a back perspective view of a further alternative embodiment of the massage cushion of the present invention.

FIG. 7 is a front perspective view of an alternative embodiment of a massage actuator of the massage cushion of FIG. 6.

### DETAILED DESCRIPTION OF THE PREFERRED EMBODIMENTS

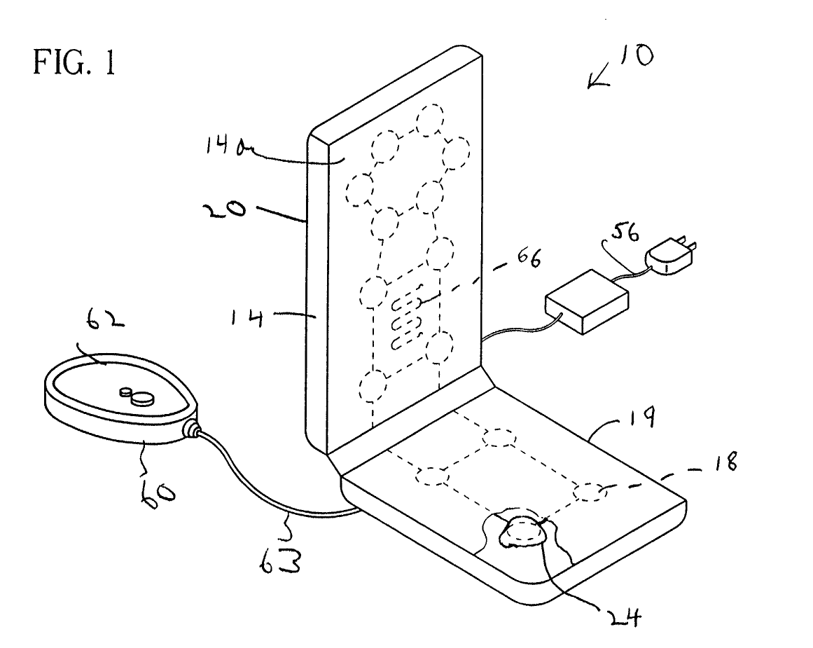

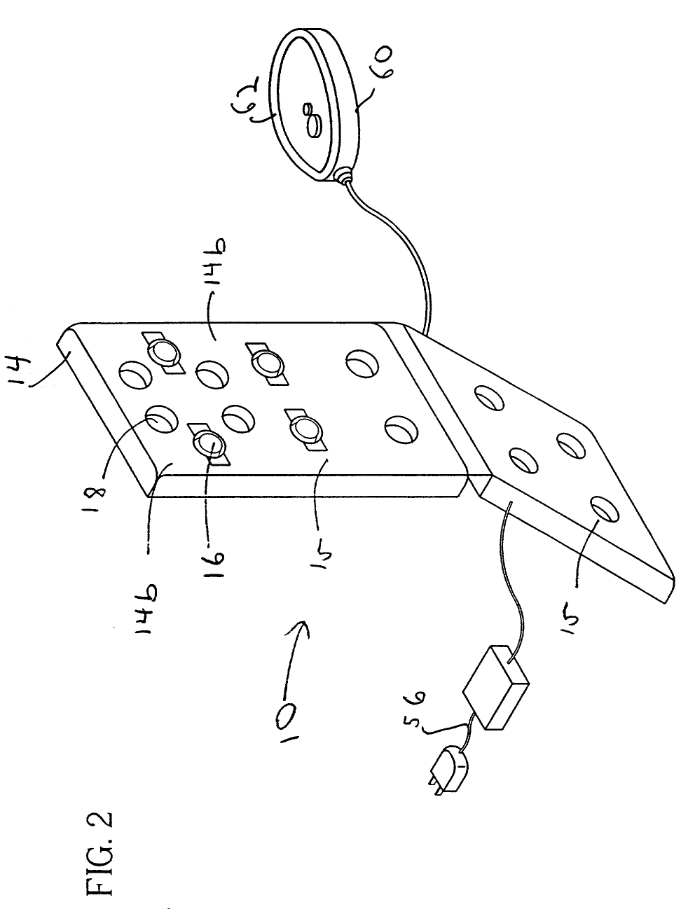

Referring to the drawings and in particular FIG. 1, there is provided a massage pad of the present invention generally represented by reference numeral 10. Massage pad 10 of the present invention provides a user with the ability to selectively position massage actuators at different locations of a cushion in order to obtain the desired massage effect. Referring to FIGS. 1 and 2, the massage pad 10 generally includes a cushioned surface 14 having an attachment surface 15 that may include an array of spaced pockets 18 formed therein and a plurality or number of massage actuators 16 selectively insertable in cavity-like pockets 18. Cushion 14 has preferably includes a seat portion 19 and backrest portion 20 to accommodate a user in the seated position. However, it is within the contemplation of the present invention that the cushion may take a variety of configurations including a pad that is attachable to a particular part of the body such as the legs, arms or back.

Cushion 14 is preferably formed of a resilient material to provide a padded base for supporting the vibration actuators. The front side 14a of cushion may include a relatively smooth surface adapted to comfortably engage a user's body. Alternatively, front surface 14a may include a plurality or number of raised protrusions (not shown), which resiliently support one's body. The reverse side 14b of the cushion may include a series of pockets 18 each adapted to receive a separate one of the massage actuators 16. The number of pockets 18 may be varied depending on the size of the cushion 14 and the degree of positional adjustablity. Massage actuators 16 are preferable vibrating devices, which may include an electric motor driving an eccentric cam as is well known in the art. Alternatively, massage actuators 16 may include any device that would generate a massage action such as a kneading, reciprocating, tapping or oscillating motion. Cushion 14 may include an array of pockets 18, which gives a user the ability to place the massage actuator 16 in the most desired position. For example, if a particular area of one's back is in need of massaging, a user may place massage actuators 16 in the appropriate locations for massaging the desired area of the body. The number of massage actuators 16 may vary from just one to a number equal to the number of pockets 18.

In the preferred embodiment, cushion 14 may include a cushioning material 24 such as a gel packet disposed between actuator pockets 18 and the front surface of cushion 14. The cushioning material 24 would help distribute the massage action in a comfortable manner. Cushion 14 may further include protrusions or nodes extending outwardly from the front surface of the cushion. The nodes may be formed of resilient material in order to provide a cushioned vibration. This cushioning may be enhanced by the use of cushioning material 24 disposed between the surface of the node and the actuator inserted within the corresponding pocket 18. Alternatively, some or all of the nodes may be rigid members providing a different type of massage therapy. The present invention contemplates that the front surface of cushion 14 may take a variety of shapes and forms in order to achieve a desired massage characteristic.

Referring to FIG. 2, a massage actuator 16 may be selectively placed in any one of the pockets 18 formed in cushion 12 by the user. The particular pocket 18 selected would be positioned such that when massage pad 10 is used, the actuator 16 would act on a desired portion of the body. Massage actuators 16 are removably attached to pockets 18, thereby permitting the actuators to be repositioned within cushion 12 as desired. The ability to move message actuators 16 between the various pockets 18 allows for a wide range of coverage with a limited number of massage actuators.

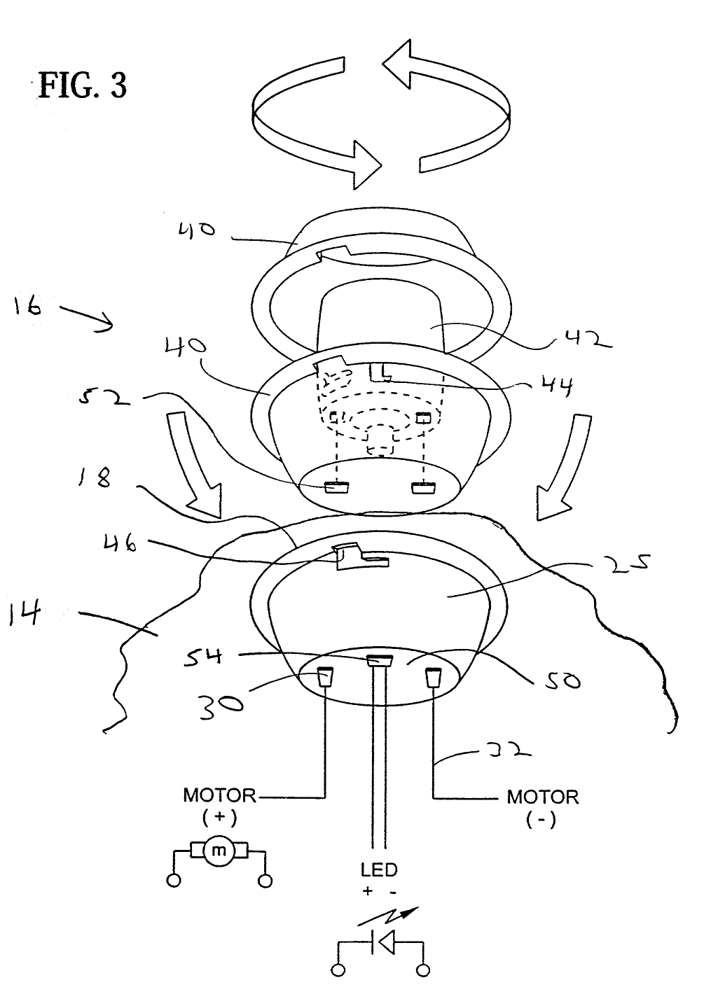

With reference to FIG. 3, each massage actuator 16 may include an electric motor 42 that can create a vibration for producing a messaging effect. The motor 42 may include an eccentric cam or other member, which converts the rotation of the motor into a suitable vibration as is known in the art. Motor 42 may be contained in a two-part housing 40, which is then inserted into one of the pockets 18. Each pocket 18 may include a cup-shaped body 25 fixedly secured to cushion 14 and sized to retain motor housing 40. Housing 40 may include tab 44 extending therefrom, which engages a slot 46 formed in pocket 18. The configuration of tab 44 and slot 46 may be such that locking engagement between housing 40 and pocket 18 is achieved by rotating the housing relative to the pocket. Reversing rotation would release actuator 16 from pocket 18 in order to permit the actuator to be inserted in another pocket. Moreover, in an alternative embodiment, the body of motor 42 itself may be adapted to directly be attachable to a pocket 18.

It is within the contemplation of the present invention that mechanical connection between cushion 14 and massage actuator 16 may be effected by a number of known attachment methods including threads, clips, snaps, hooks, straps, hook and loop strips and the like. Alternatively, pockets 18 may be partially covered by material (not shown) that would permit an actuator 16 to be removably retained therein.

Once the massage actuator 16 is inserted in a particular pocket 18, it may be energized, causing the corresponding portion of the cushion on the front of the cushion to vibrate as desired. In the preferred embodiment, each pocket 18 includes electrical connectors 30 connected to wiring 32 for supplying power to the massage actuator 16. Wiring 32 may be integrated with cushion 14 and formed beneath an outer covering layer 14a thereof (shown in FIG. 1). Connectors 30 are preferably located on a base wall 50 of pocket body 25, and are positioned to align with contacts 52 positioned on the front face of motor housing 40 when massage actuator 16 is secured in pocket 18. Contacts 52 are electrically connected to motor 42 contained in motor housing 40. Pocket body base wall 50 may further include a sensor 54 that activates when actuator 16 is inserted in pocket 18. Sensor 54 may be in the form of a micro switch or proximity sensor, and upon activation thereof sends a signal to a controller 60 indicating that a message actuator 16 is inserted in a particular pocket 18. Electrical power may be supplied by a corded plug 56 that can be connected to a standard household outlet. Power may alternatively be supplied by a vehicle, such as a car, by interfacing with a power outlet.

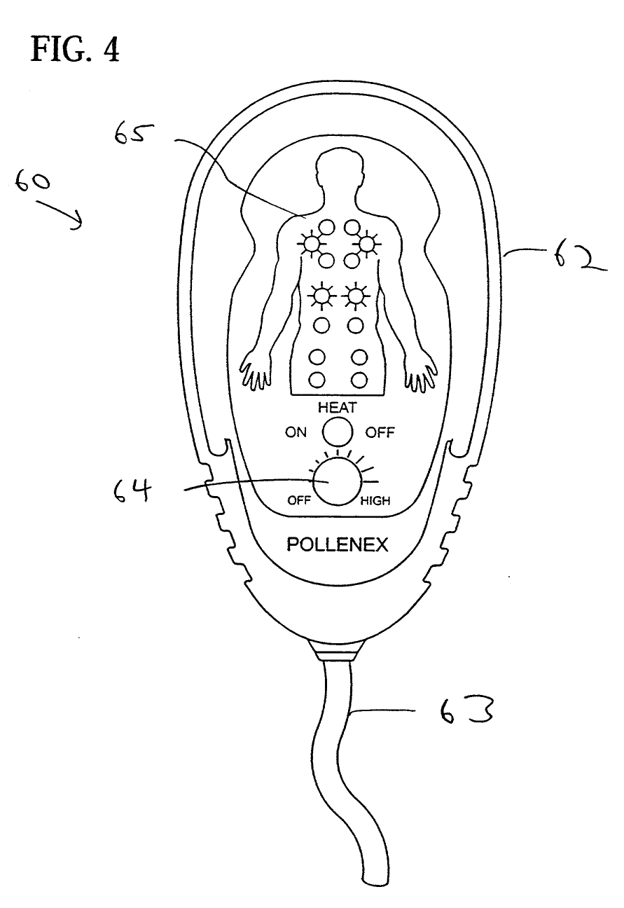

With reference to FIG. 4, controller 60 is preferably wired to each pocket 18 to permit massage actuators 16 to be centrally controlled by a user when the actuators are placed in any of the pockets 18. Controller 60 may include a hand held unit 62 operatively connected to cushion 14 by a flexible cable. Various controls 64 and displays 65 are disposed on controller 60 to permit a user to operate the desired actuators 16 secured to cushion 14. Alternatively, controller 60 may be secured directly to cushion 14 or located remotely therefrom and have the ability to operate pad 10 by the emission of radio or infrared signals.

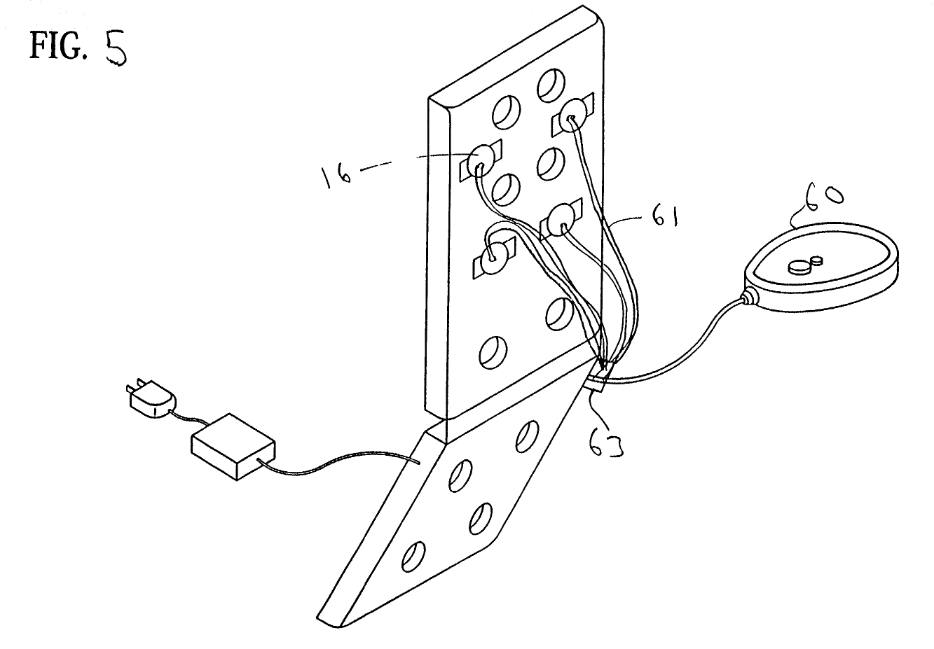

In an alternative embodiment shown in FIG. 5, massage actuators 16 may be connected to wires 61 that are external to the cushion. The wires 16 may terminate in a junction 63 connected to controller 60 permitting each of the actuators 16 to be controlled in a convenient manner by a user. The connecting wires 16 would preferably be of such a length to permit the actuators 16 to be placed in any one of the pockets 18.

In the preferred embodiment, controller 60 permits a user to activate each actuator 16 inserted in a pocket 18. Accordingly, when a user-operated switch 64 on controller 60 is turned on, each of the massage actuators 16 will begin to vibrate. Controller 60 may also regulate the intensity of vibration by varying the speed of the motors 42, and may control power to heating element 66 supported by cushion 14. A signal sent by an activated sensor 54 is sent to controller 60 and may activate a display to indicate that a particular pocket 18 contains a massage actuator 16. Sensors 54 may be employed to control energizing the contact in the pockets 18. For example, in unoccupied pockets 18 the inactivated sensor may prevent the connectors therein from being energized in order top prevent unwanted contact with electrified components.

In an alternative embodiment, controller 60 may be used to turn on specific individual pockets 18 and the actuators 16 inserted therein. This may be achieved by including controller 60 located switches corresponding to each pocket 18. Alternatively, the controller 60 may provide a user the ability to selectively energize pockets 18 within various predetermined zones, e.g. seat or backrest. In this embodiment, any actuator 16 located in a particular zone would be energized.

Such selective control may be achieved by circuitry well known in the art. The controller 60 may further provide sequencing of the various actuators 16, alternating one or more on or off at a particular time in a manner which is well known in the massage cushion art.

By permitting massager actuators 16 to be selectively positioned in the various pockets 18, the present invention can accommodate a wide range of physiological variations between users and permit a wide range of areas to be massaged while using only a limited number of massage actuators 16. This provides a cost benefit in that only a limited number of actuators 16 are required. It also provides flexibility to permit the user to ensure that the massage action is located at the optimum location.

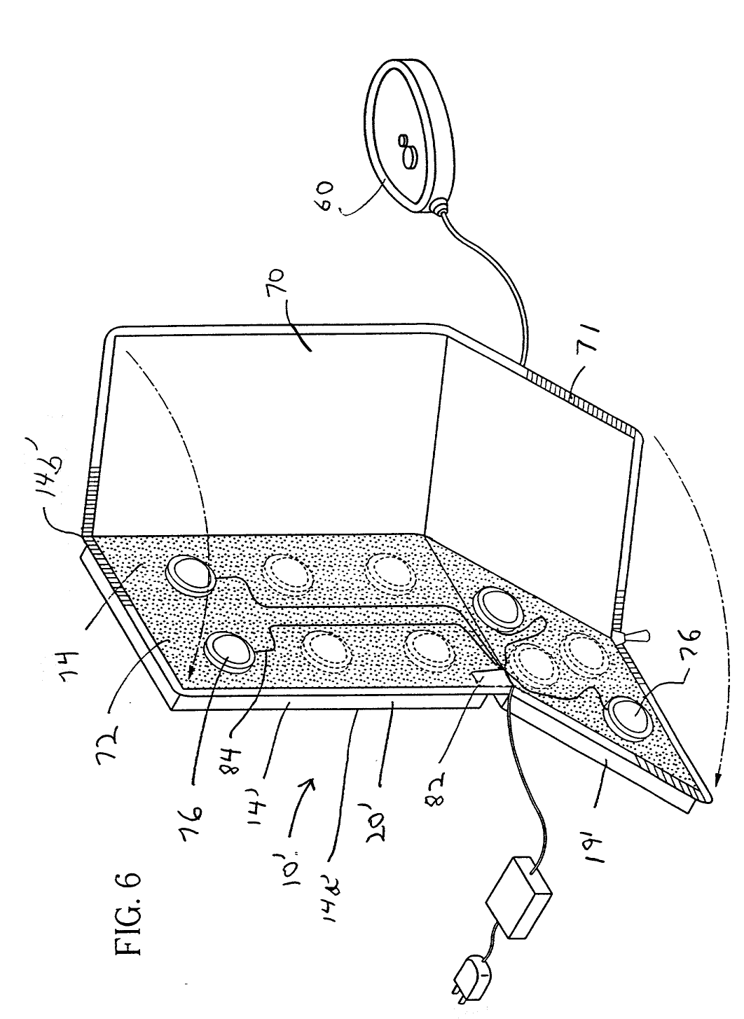

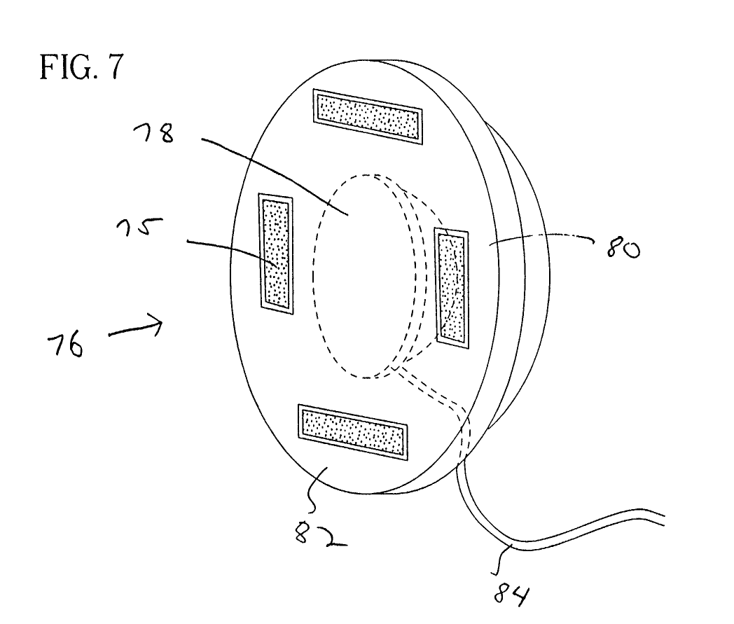

Referring to FIGS. 6 and 7, a further alternative embodiment of the massaging pad 10′ of the present invention is provided. Massage pad 10′ includes a cushioned surface 14′ having a seat portion 19′ and a backrest portion 20′. The front side 14a′ of cushion 14′ may be formed similarly to that of the embodiment shown in FIG. 1. However, the back surface 14b′ is modified to include a flap 70 that selectively covers an actuator attachment surface 72 extending along the length and width of massage pad 10′. Flap 70 may be releasable securable to back surface 14b′ by way of a fastener 71, which may include a zipper, hook and loop, snaps or any of a number of well known fastener devices. Attachment surface 72 includes a first attachment device 74, which cooperates with a second attachment device 75 secured to movable massage actuators 76.

In this embodiment, massage actuators 76 may include an eccentric motor 78 covered in a resilient material 80 to form a pod-like structure, which vibrates when energized. Alternatively, massage actuators 76 may include any device that would generate a massage action such as a kneading, reciprocating, tapping or oscillating motion. Each massage actuator 76 includes a mounting surface 82 that includes second attachment device 75. In the preferred embodiment, first and second attachment devices, 74 and 75, are each one part of a hook and loop attachment system of the type well known in the art. It is within the contemplation of the present invention the first and second attachment devices 74, 75 may be any one of a number of well known securement devices such as snaps, button, hooks, clips, etc.

As in the embodiment shown in FIG. 5, each massage actuator 76 is connected to a junction 82 by its own wire 84. A user is free to place a massage actuator 76 on any desired location of the attachment surface 72. Accordingly, a user has an infinite possibility of locations to attach massage actuators 76 that the desired areas of the body can receive stimulation. Several alternative massager locations are shown in phantom in FIG. 6. Once massage actuators 76 are positioned as desired, flap 70 may be closed to cover attachment surface 72 and the massage actuators secured thereto. Adjusting a massage actuator's location, merely requires opening flap 70 and pulling an actuator 76 loose from attachment surface 72 and reattaching the actuator to its new location. By operating controller 60, a user may energize each massage actuator 76 to provide the vibratory massage action.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A massage pad comprising:
a surface for removably retaining one or more selectively positionable massage actuators.

2. The massage pad of claim 1, wherein the massage pad is formed of a resilient material.

3. The massage pad of claim 1, wherein the massage pad has one or more removable gel packs disposed therein.

4. The massage pad of claim 1, wherein the massage pad has one or more protrusions extending outwardly therefrom.

5. The massage pad of claim 4, wherein said one or more protrusions are formed of a resilient material to provide a more cushioned massaging effect.

7. The massage pad of claim 4, wherein said one or more protrusions are rigid to provide a more intense massaging effect.

8. The massage pad of claim 1, wherein said surface has one or more pockets for selectively retaining said one or more massage actuators.

9. The massage pad of claim 8, wherein said one or more massage actuators are vibrating motors selectively positionable in said one or more pockets.

10. The massage pad of claim 1, wherein said surface has one or more first connectors, and wherein said one or more massage actuators each has a second connector connectable with said one or more first connectors.

11. The massage pad of claim 10, wherein said one or more massage actuators are vibrating motors connectable with said one or more first connectors.

12. The massage pad of claim 1, wherein the massage pad has a seat portion and a backrest portion to accommodate a user in a seated position.

13. The massage pad of claim 1, wherein the massage pad can be attached to a particular body part.

14. The massage pad of claim 1, further comprising a controller for controlling the energizing of said one or more massage actuators.

15. The massage pad of claim 14, wherein said controller is electrically connected to said one or more massage actuators.

16. The massaging pad of claim 15, wherein said controller is integrated with said surface such that said controller is accessible to a user.

17. The massaging pad of claim 15, wherein said controller is remote from the massage pad and said one or more massage actuators.

18. The massaging pad of claim 17, wherein said controller and said one or more massage actuators cooperate to provide a user with a variety of different massage effects.

19. A massage pad comprising:
one or more selectively positionable massage actuators;
a heating element supported by the massage pad;
a surface for removably retaining said one or more massage actuators; and
a controller for controlling the actuation of said one or more massage actuators and said heating element.

20. The massage pad of claim 19, wherein said surface has a flap to selectively cover said one or more massage actuators.

21. The massage pad of claim 19, wherein said controller is remote from the massage pad and said one or more massage actuators.

22. The massage pad of claim 19, wherein said surface can be combined with a variety of different therapeutic structures to facilitate a variety of different massaging effects.
